(19) United States
(12) Patent Application Publication
(10) Pub. No.: US 2026/0188136 A1
(43) Pub. Date: Jul. 2, 2026

(54) ARTIFICIAL INTELLIGENCE BASED GRADING OF WRITTEN RESPONSE TESTS

(71) Applicants: Constructor Technology AG, Schaffhausen (CH); Constructor Education and Research Genossenschaft, Schaffhausen (CH)

(72) Inventors: Andrey ADASHCHIK, Istanbul (TR); Rasilia RAKHMATULINA, Sofia (BG); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/003,810

(22) Filed: Dec. 27, 2024

(51) Int. Cl. G09B 7/02

(52) U.S. Cl. CPC G09B 7/02

(57) ABSTRACT

Disclosed herein are systems and methods for automated grading of written response tests. The method includes obtaining course material, test materials for a plurality of courses offered by an academic institution, a standardized scoring rubric for a plurality of tests and different courses, and grading guidelines comprising test scoring rules for the written response test or course. The method further includes analyzing the course materials and test materials using a trained rubric customizer LLM. The method also includes obtaining a written response from a learner for a test in a course taken by the learner. The method further includes analyzing the written response using two or more trained test grading LLM agents executing in parallel with each other. The method further includes combining, by a scoring engine, a plurality of criteria scores from the one or more trained test grading LLM agents. The method further includes generating a grading report.

### FIELD OF TECHNOLOGY

The present disclosure relates to the field of examination proctoring, and, more specifically, to systems and methods for machine-learning based methods for automated grading of written response tests.

### BACKGROUND

Examinations are now commonly taken on computers, offering convenience and accessibility for both learners and institutions. These computer examinations are conducted through specialized software or platforms that allow learners to take tests requiring a written response. They often include features like automated proctoring, performance analysis, and instant grading. However, grading examinations or assignments that consist of open-ended written responses presents several challenges and issues due to the nuanced nature of language, diversity of writing, and complexity of human expression. One major concern is that computers may struggle to accurately understand and evaluate creative or interpretive responses such as essays or open-ended questions, where there is no single correct answer. In addition, writing style, tone, and rhetorical effectiveness are subjective and hard to quantify algorithmically. In addition, computers may misinterpret words or phrases that depend on specific contexts, leading to inaccurate assessments. In addition, automated systems that rely on rigid grading rubrics can penalize learners for valid responses that fall outside of those predefined expectations. Thus, teachers, learners, and parents may resist the use of computer grading due to concerns over reliability and fairness.

### SUMMARY

To address the shortcoming of online proctoring systems, the present disclosure describes a system and method for automated grading of written response tests. Some of the technical improvements of the present disclosure is the ability to train and use machine learning models (MLM) to efficiently grade written responses using machine-learning based methods by automating the grading process without the need for manual grading, and making it suitable for large-scale assessments. In addition, the present disclosure describes using trained MLMs to provide immediate, personalized feedback in response to grading the written responses. By analyzing vast amounts of data, MLMs can develop customized scoring rubrics for each test or course. In addition, by utilizing different test grading MLM models associated with a particular grading criteria from the customized scoring rubric, each MLM agent can analyze written responses based on a single respective grading criteria from the customized scoring rubric and generate an individual criteria score for the single grading criteria. The use of parallel processing by the different test grading MLM agents associated with a particular criteria also results in decrease of hallucinations as well as an increase in speed as compared to using a general MLM model for a combination of grading criteria. This also leads to a more accurate grading or scoring by combining different criteria scores according to different test scoring rules from grading guidelines. In addition, the present disclosure describes generating a detailed grading report including at least a test score for the written response, individual criteria scores, and customized descriptions for the grading criteria from a customized scoring rubric.

Other technical benefits of the present disclosure include implementing an efficient and consistent grading and analysis system because automated grading and feedback generation eliminates human error and bias, ensuring consistent and objective evaluation across different users and written response exams. The MLMs may also incorporate feedback from teachers or tutors to tailor the customized scoring rubric easily and quickly. Finally, the present disclosure provides continuous improvement of the grading and analysis system over time since MLMs can refine their feedback generation capabilities by learning from a continuously growing body of data in order to improve their effectiveness and relevance as more users use the system to grade written responses.

In one exemplary aspect, a method for automated grading of written response tests is disclosed. The method includes: obtaining course material and test materials for a plurality of different courses offered by an academic institution, wherein the test materials comprises a written response test; obtaining a standardized scoring rubric for a plurality of tests and different courses, wherein the standardized scoring rubric is the same for the plurality of courses; obtaining grading guidelines comprising test scoring rules for the written response test or course; analyzing the course materials and test materials using a prepared rubric customizer machine learning model (MLM) configured to generate a customized scoring rubric for the written response test or course based on the standardized scoring rubric, wherein the customized scoring rubric comprises at least a list of different grading criteria, customized descriptions for each grading criteria based at least on subject matter of the written response test and/or course, and criteria score levels for each grading criteria, obtaining a written response from a learner for a test in a course taken by the learner; analyzing the written response using two or more prepared test grading MLM agents executing in parallel with each other, wherein each test grading MLM agent is associated with a single grading criteria from the customized scoring rubric and configured to analyze the written response based on the single grading criteria from the customized scoring rubric for the written response test and/or course and to generate a criteria score for the single grading criteria; combining, by a scoring engine, a plurality of criteria scores from the two or more prepared test grading MLM agents according to the test scoring rules from the grading guidelines for the written response test and/or course to compute a test score for the written response test; and generating, for display on a user interface (UI), a grading report comprising at least: the test score for the written response test, the plurality of criteria scores, or descriptions for the grading criteria from the customized scoring rubric for the written response test.

In some aspects, the techniques described herein relate to a method, wherein analyzing the written response using the two or more prepared test grading MLM agents further comprises: selecting the two or more prepared test grading MLM agents from a plurality of prepared test grading MLM agents based on the different grading criteria from the customized scoring rubric for each written response test and/or course.

In some aspects, the techniques described herein relate to a method, wherein the grading criteria from the customed scoring rubric for the test and/or course comprises at least two of: persuasion, accuracy, organization, style, voice, content, efficiency, or conventions.

In some aspects, the techniques described herein relate to a method, further including: preparing the rubric customizer MLM by: (i) providing, to the rubric customizer MLM, a training dataset comprising: (a) a plurality of standardized scoring rubrics used across different courses and tests, (b) a plurality of customized scoring rubrics comprising at least detailed criteria descriptions of each grading criteria, (c) descriptions of different proficiency levels and corresponding criteria for each level, (d) course material outlining subject matter and learning objectives of each course, and (e) test material comprising at least questions, answer keys, and example written responses in a variety of subjects and difficulty levels, wherein the example written responses comprises a variety of written responses each labeled with a grade, score, or feedback, and (ii) training the rubric customizer MLM using the provided training dataset.

In some aspects, the techniques described herein relate to a method, further including: preparing a first test grading MLM agent among the two or more prepared test grading MLM agents executing in parallel with each other by: (i) providing, to the first test grading MLM agent, a first criteria training dataset comprising: (a) a plurality of customized scoring rubrics comprising at least detailed criteria descriptions of each grading criteria, (b) a plurality of course material and test materials, (c) a plurality of graded written responses categorized by topics and particular to a first criteria associated with the first test grading MLM agent comprising at least scores and feedback, and (d) descriptions of different proficiency levels and criteria for each level particular to the first criteria associated with the first test grading MLM agent, and (ii) training the first test grading MLM agent using the provided first criteria training dataset.

In some aspects, the techniques described herein relate to a method, further including: preparing a second test grading MLM agent among the two or more trained test grading MLM agents executing in parallel with each other by: (i) providing, to the second test grading MLM agent, a second criteria training dataset comprising: (a) a plurality of customized scoring rubrics comprising at least detailed criteria descriptions of each grading criteria, (b) a plurality of course material and test materials, (c) a plurality of graded written responses categorized by topics and particular to a second criteria associated with the first test grading MLM agent comprising at least scores and feedback, wherein the second criteria is different from the first criteria, and (d) descriptions of different proficiency levels and criteria for each level particular to the criteria associated with the first test grading MLM agent, and (ii) training the second test grading MLM agent using the provided second criteria training dataset, wherein the second test grading MLM agent is different from the first test grading MLM agent.

In some aspects, the techniques described herein relate to a method further including: analyzing the written response using the two or more trained test grading LLM agents further comprises: selecting the two or more trained test grading MLM agents from a plurality of trained test grading MLM agents based on grading criteria from the customized scoring rubric for the test and/or course.

According to one aspect of the disclosure, a system is provided for automated grading of written response tests, the system including: at least one memory; and at least one hardware processor coupled with the at least one memory and configured, individually or in combination, to: obtain course material and test materials for a plurality of different courses offered by an academic institution, wherein the test materials comprises a written response test; obtain a standardized scoring rubric for a plurality of tests and different courses, wherein the standardized scoring rubric is the same for the plurality of courses; obtain grading guidelines comprising test scoring rules for the written response test or course; analyze the course materials and test materials using a prepared rubric customizer machine learning model (MLM) configured to generate a customized scoring rubric for each written response test or course based on the standardized scoring rubric, wherein the customized scoring rubric comprises at least a list of different grading criteria, customized descriptions for each grading criteria based at least on subject matter of each written response test and/or course, and criteria score levels for the grading criteria; obtain a written response from a learner for a test in a course taken by the learner; analyze the written response using two or more prepared test grading MLM agents executing in parallel with each other, wherein each test grading MLM agent is associated with a single grading criteria from the customized scoring rubric and configured to analyze the written response based on the single grading criteria from the customized scoring rubric for the written response test and/or course and to generate a criteria score for the single grading criteria; combine, by a scoring engine, a plurality of criteria scores from the two or more prepared test grading MLM agents according to the test scoring rules from the grading guidelines for the written response test and/or course to compute a test score for the written response test; and generate, for display on a user interface (UI), a grading report comprising at least: the test score for the written response test, the plurality of criteria scores, or descriptions for the grading criteria from the customized scoring rubric for the written response test.

In one exemplary aspect, a non-transitory computer-readable medium is provided storing a set of instructions thereon for automated grading of written response tests, the system, including instructions for: obtaining course material and test materials for a plurality of different courses offered by an academic institution, wherein the test materials comprises a written response test; obtaining a standardized scoring rubric for a plurality of tests and different courses, wherein the standardized scoring rubric is the same for the plurality of courses; obtaining grading guidelines comprising test scoring rules for the written response test or course; analyzing the course materials and test materials using a prepared rubric customizer machine learning model (MLM) configured to generate a customized scoring rubric for the written response test or course based on the standardized scoring rubric, wherein the customized scoring rubric comprises at least a list of different grading criteria, customized descriptions for each grading criteria based at least on subject matter of the written response test and/or course, and criteria score levels for each grading criteria; obtaining a written response from a learner for a test in a course taken by the learner; analyzing the written response using two or more prepared test grading MLM agents executing in parallel with each other, wherein each test grading MLM agent is associated with a single grading criteria from the customized scoring rubric and configured to analyze the written response based on the single grading criteria from the customized scoring rubric for the written response test and/or course and to generate a criteria score for the single grading criteria; combining, by a scoring engine, a plurality of criteria scores from the two or more prepared test grading MLM agents according to the test scoring rules from the grading guidelines for the written response test and/or course to compute a test score for the written response test; and generating, for display on a user interface (UI), a grading report comprising at least: the test score for the written response test, the plurality of criteria scores, or descriptions for the grading criteria from the customized scoring rubric for the written response test.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for automated grading of written response tests according to aspects of the present disclosure.

FIG. 2 is a block diagram illustrating a system for training machine learning models to grade and provide feedback for written response tests according to aspects of the present disclosure.

FIG. 3 is an example method for generating a grading report based on a customized scoring rubric according to an aspect of the present disclosure.

FIG. 4 is an example of a customized scoring rubric according to aspects of the present disclosure.

FIG. 5 is an example of a graded written response and a customized scoring rubrics according to aspects of the present disclosure.

FIG. 6 is an example method for automated grading of written response tests according to aspects of the present disclosure.

FIG. 7 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for automated grading of written response tests. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Grading written response test (or assignments) completed by learners is essential for assessing how well learners understand and can apply material that they've learned. Unlike multiple-choice questions, written responses require learners to explain, analyze, and synthesize information which better demonstrates their depth of comprehension. In addition, written response tests encourage learners to think critically and logically due to the need to construct coherent arguments, organize their thoughts clearly, and support their points with evidence or reasoning. Written response tests also help learners to practice their communication skills. In addition, through written response tests and different scoring criteria, instructors can provide targeted feedback on a learner's individual strengths and weaknesses to help learners understand their mistakes and areas for improvement. Finally, grading written responses requires a set of criteria and clear rubrics to allow for more individualized and nuanced assessment compared to other forms of testing.

In addition, a grading report that contains an overall test score for the written response along with a plurality of criteria scores, and/or descriptions for the grading criteria from a customized scoring rubric for the examination and/or course enhances the grading process by providing additional scoring detail. Instead of simply providing an overall score for the written response, the plurality of individual criteria scores and customized descriptions for the grading criteria offer personalized feedback and strategies for improvement. This approach is a significant improvement over conventional methods that often focus on summative results without providing guidance for ongoing development. By offering more detailed grading, learners gain additional insight into their performance on a written response.

Technological advancements have further improved the effectiveness of both grading and generating grading reports for written response tests. For example, a MLM may be prepared to generate a customized scoring rubric for a written response test or course based on analyzing at least course materials and test materials. As another example, test grading agents may prepared to be associated with a particular criteria from the customized scoring rubric and configured to analyze written responses based on a particular grading criteria and generate a criteria score for the particular criteria. These automated systems can quickly generate detailed and customized scoring rubrics for a written response and grade the written responses based on the customized scoring rubric to provide a more detailed analysis of the written response for each learner. Compared to traditional methods that may rely on generating a single overall score for a written response test, these technological tools allow for a more precise, timely, and data-driven assessment. By leveraging technology, teachers can utilize an automated process for grading written response tests.

Accordingly, the present disclosure assesses written response tests and provides a detailed grading report of the written response test for a learner after the learner takes the written response test. One aspect involves generates a customized scoring rubric for a written response test based on course material and/or test material by utilizing a trained rubric customer MLM configured to generate a customized scoring rubric for each test or course based on a standardized scoring rubric. A second aspect involves analyzing the written response using a plurality of test grading MLM agents executing in parallel with each other to generate a plurality of criteria scores according to the customized scoring rubric. A third aspect involves generating a detailed grading report for the written response comprising at least an overall test score for the written response and a plurality of criteria scores and/or descriptions of each grading criteria from the customized scoring rubric.

Turning now to the figures, example aspects are depicted with reference to one or more components described herein, where components in dashed lines may be optional.

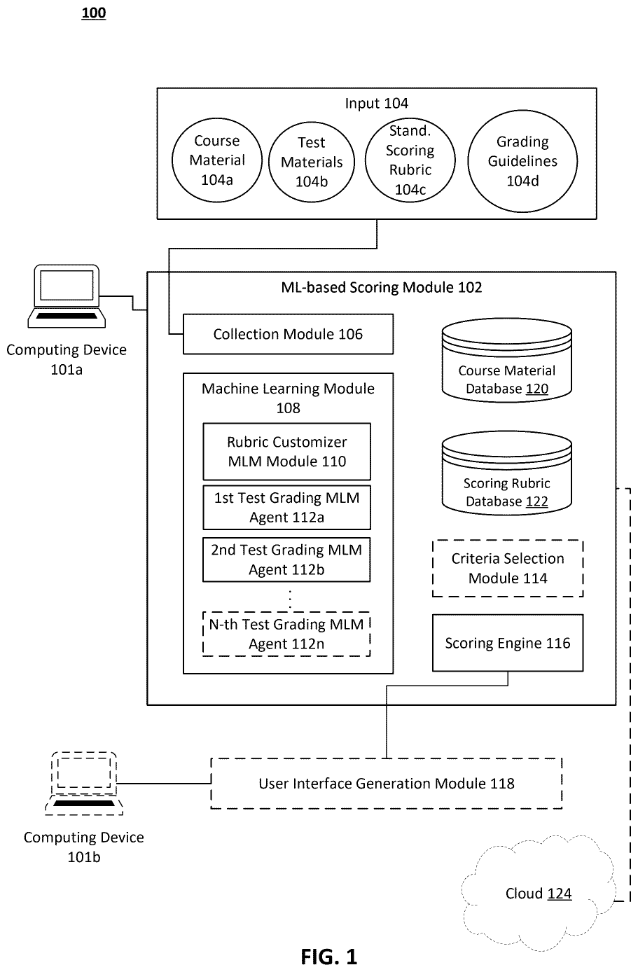

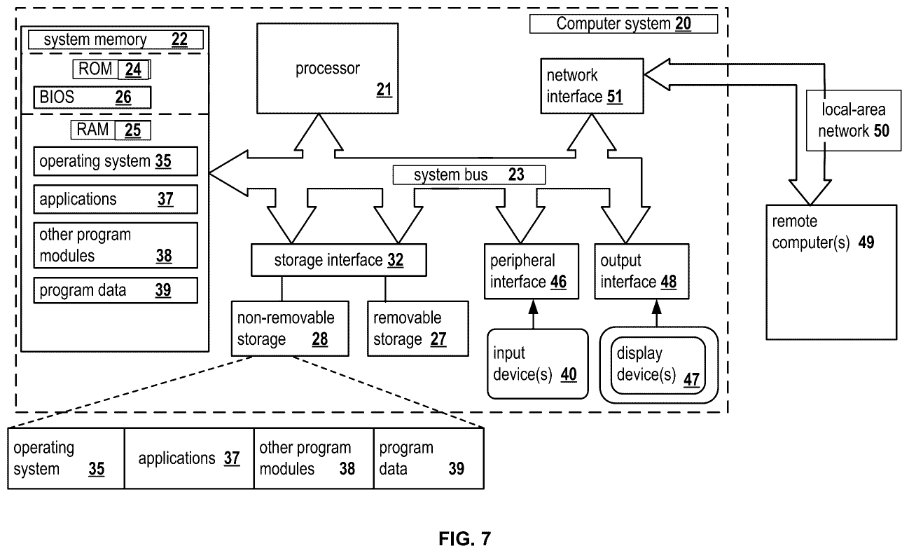

FIG. 1 is a block diagram illustrating a system 100 configured to perform automated grading of written response tests. In one aspect, the components of system 100 may be implemented on computer systems, such as that shown in FIG. 7.

The system 100 may be used to generate a customized scoring rubric for a written response test and/or course and then assess and generate a grading report for the written test or course based on the customized scoring rubric. This provides a way to implement an automated grading process for written responses tests that contains a grading report with more feedback and detail than simply presenting an overall score without any explanation of how or why the overall score was calculated. The grading report may include at least a test score for the written response, a plurality of criteria scores and/or descriptions of each criteria from the customized scoring rubric for the test. The grading report is designed to be more constructive by providing a learner with more detailed feedback of their performance on the written response by providing descriptions for each grading criteria (e.g., content, style, analysis, etc.) considered in an overall score and individual scores for each grading criteria. In this way, the ML-based scoring module 102 may quickly analyze written response tests from learners and generate a detailed scoring report for each learner.

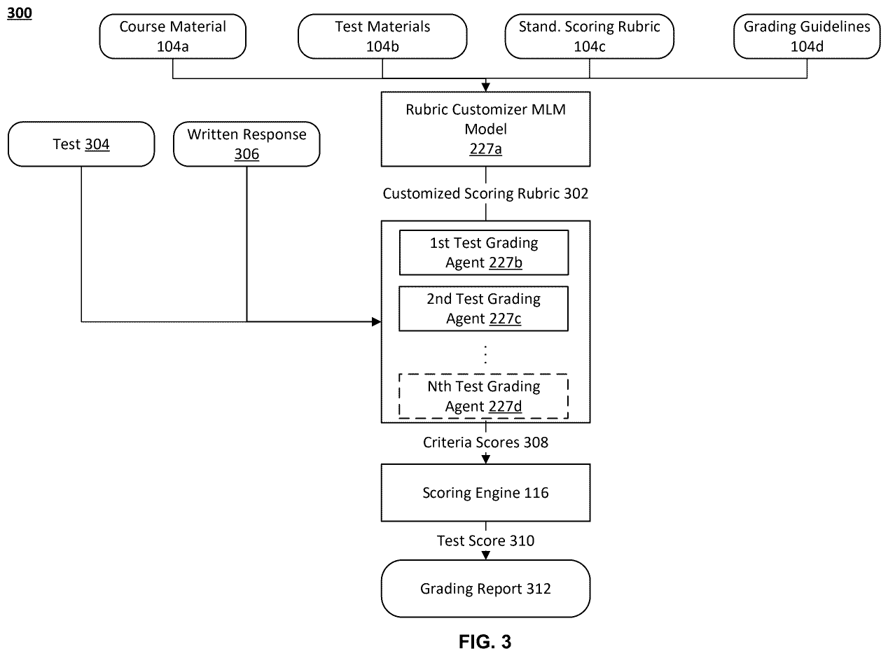

The system 100 includes at least an input 104 (e.g., course material 104a, test material 104b, standard scoring rubric 104c, and grading guidelines 104d), a computing device 101a and the ML-based scoring module 102. In some aspects, the system 100 may also include an optional user interface (UI) generation 118 module and an optional second computing device 101b. Specifically, the ML-based scoring module 102 may be configured to process and generate a customized scoring rubric (e.g., the customized scoring rubric 302 shown in FIG. 3) for a written response (e.g., written response 306 shown in FIG. 3) based on the course material 104a, the test materials 104b, the standard scoring rubric 104c and/or the grading guidelines 104d. In addition, the ML-based scoring module 102 is configured to analyze the written response test and generate a detailed scoring report (e.g., grading report 312 shown in FIG. 3) for the written response test based on the customized scoring rubric.

In some aspects, the computing device 101a allows a teacher or faculty to generate the customized scoring rubric for each test (e.g., written response test) or course and then analyze and grade each written response test according to the customized scoring rubric. The computing device 101a may execute a plurality of modules in the ML-based scoring module 102 that together make up the collection, generation, analysis, and scoring system. In some aspects, the ML-based scoring module 102 may correspond to the computing device 101a or a cloud network 124 that is configured to execute a plurality of modules that together make up the ML-based scoring module 102 for collecting the inputs, generating a customized rubric, and analyzing and scoring written response tests using the customized scoring rubric.

In some aspects, the ML-based scoring module 102 may include a collection module 106, a ML module 108 including at least a rubric customizer MLM module 110, a first test grading MLM agent 112a, a second test grading MLM agent 112b, an optional Nth test grading MLM agent 112n, an optional criteria selection module 114, a scoring engine 116, a course material database 120, and a scoring rubric database 122.

The computing device 101a may execute the collection module 106 that collects and obtains course material 104a, test materials 104b, standard scoring rubric 104c, and a grading guidelines 104d in order to generate a customized scoring rubric for a written response test and to evaluate and score the written response test using the customized scoring rubric. In some aspects, portions of the course material 104a, test materials 104b, standard scoring rubric 104c, and grading guidelines 104d may be stored on a local computing device or a cloud network 124. In some aspects, the course material 104a may be stored and accessed from a course material database 120. In some aspects, the standard scoring rubric 104c may be stored and accessed from a scoring rubric database 122.

Grading written response tests involve evaluating how well a learner's written answers aligns with the concepts, theories, or guidelines presented in the course material 104a. For example, the course material 104a may refer to resources and content provided or recommended for learning in a particular course. As a non-limiting example, the course material 104a may include at least textbooks, lectures/slide decks, supplemental readings, assignment/practice questions, and/or multimedia resources. Accordingly, the course material 104a may be analyzed to create a detailed customized scoring rubric outlining criteria such as content accuracy, completeness, relevance, and critical thinking such that the course material 104a may be the standard for correct and expected answers. The course material 104a may also be used to assess whether a learner incorporates the key concepts, theories, or definitions explicitly discussed in the course. In addition, course material 104a may be used to assess the depth of analysis by comparing the learner's arguments with the perspectives or methods introduced in the course. By utilizing course materials 104a as a framework for the scoring rubric, the present disclosure ensures grading is objective, consistent, and directly tied to the course's learning outcomes.

Test materials 104b refers to the specific content, resources, instructions, or prompts provided to learners as part of a test or examination. As a non-limiting example, test materials 104b often include test questions/prompts, supplemental texts/data included with the test for analysis, and/or instructions and guidelines detailing expectations such as word count, format, and grading criteria. In addition, the test materials 104b serve as a foundation for grading written responses because the test materials 104b may define the scope of the task and the resources available to learners. As an example, if a written response test provides an article about climate change and asks learners to write an essay about the impact of human activities. Grading may involve: (1) checking if the learner uses evidence from the article (e.g., specific statistics or quotes); (2) assessing whether the learner answered all parts of the question (e.g., addressed both “human activities” and “impact”); and (3) utilizing the customized scoring rubric to evaluate content understanding based on the course material 104a, the use of evidence form the test materials 104b, and analytical depth. Accordingly, by grounding grading in the test materials 104b, the evaluation process becomes fair, objective, and tied to the goals of the assessment.

The standard scoring rubric 104c is a pre-defined, general framework for evaluating performances on tasks such as written responses. The standard scoring rubric 104c consists of criteria and descriptors that outline expected performance levels across a range of competencies or skills and are often used as templates for a variety of tasks to ensure consistency in assessment. As an example, a typical standard scoring rubric 104c may include: (1) criteria explaining the categories or aspects being assessed (e.g., clarity, grammar, critical thinking, evidence use, etc.); (2) a performance level indicating quality (e.g., excellent, good, fair, poor) or a numeric score for each criteria; and (3) descriptions detailing explanations of what constitutes performance at each level for each criterion. The standard scoring rubric 104c provides a general structure for assessment. The ML-based scoring module 102 utilizes the standard scoring rubric 104c to generate a customized scoring rubric that refines this framework to address the specific needs of the written response test.

The grading guidelines 104d are a set of principles or rules established to ensure consistency, fairness, and clarity when evaluating the written response tests. As a non-limiting example, the grading guidelines 104d often specify learning objects, criteria for success, performance standards, grading scale and/or feedback expectations by the teacher. In addition to the standard scoring rubric 104c, the grading guidelines 104d provide the framework and principles that inform the design and generation of the customized scoring rubric. As an example, for an argumentative essay, the grading guidelines may emphasize critical thinking, use of evidence, and clarity. As another example, for a history essay's grading guidelines, the grading guidelines may prioritize content understanding, use of evidence, and historical perspective. By translating the grading guidelines 104d into specific, measurable criteria with clear performance levels, teachers may create a customized scoring rubric that ensures fair, consistent, and task-aligned evaluation of written responses.

The computing device 101a may execute a ML module 108 including at least a rubric customizer MLM module 110, a first test grading MLM agent 112a, a second test grading MLM agent 112b, and an optional Nth test grading MLM agent 112n. A MLM is a program or mathematical framework trained to perform tasks by learning patterns from data, rather than following explicitly programmed rules. Core components of a MLM include: input data provided to the models for training or inference, specific attributes or characteristics of the data that the model uses for learning, variables adjusted during training to optimize the model's performance, and prediction or decision made by the model.

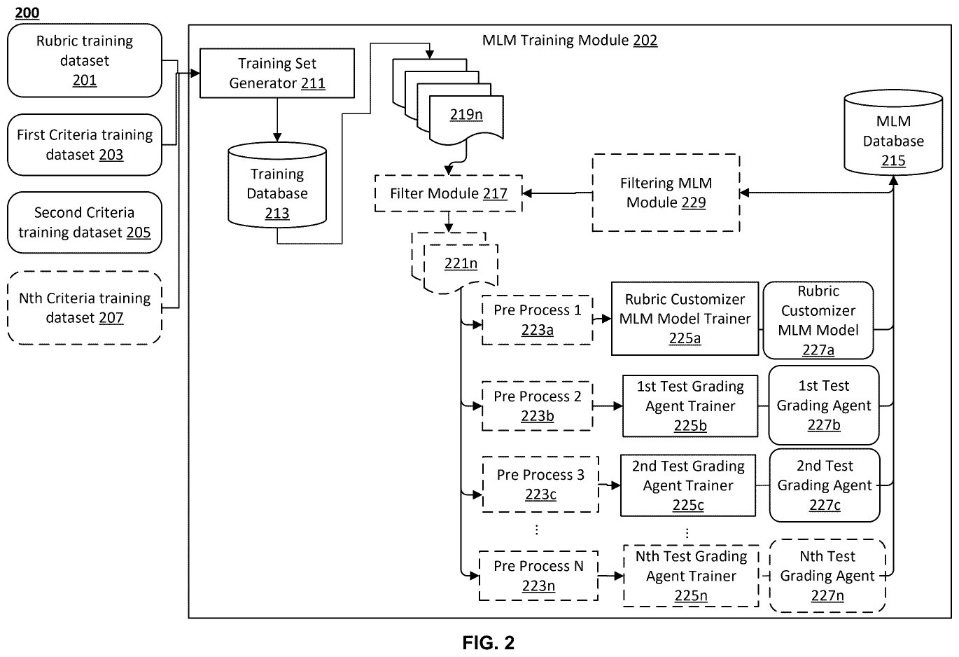

In some aspects, the prepared rubric customizer MLM (e.g., the rubric customizer MLM model 227a from FIG. 2) from the rubric customizer MLM module 110 and the test grading MLM agents (e.g., first test grading agent 227b, second test grading agent 227c, and optional nth test grading agent 227d) may correspond to large language models (LLMs). A LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through training to teach each LLM model to perform their respective specific tasks. As a nonlimiting example, the LLM models may incorporate one of the machine learning models listed below.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT).

A classification model is a type of machine learning model that is designed to predict the category or class to which a given data point belongs to. The classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machine (SVM) configured to perform classification by finding the best boundary between classes, and neural networks.

In some examples, the ML module 108 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by the ML module 108 may be one of the following: transformer neural network, convolution neural network (CNN), recurrent neural network (RNN), long short-term memory (LSTM) network, gated recurrent unit (GRU) network, autoencoder, generative adversarial network (GAN).

An autoencoder is a type of neural network used for unsupervised learning and dimensionality reduction, and consists of an encoder that compresses input data into a lower-dimensional representation (encoding) and a decoder that reconstructs the original input from the encoding.

For analysis tasks such as generating a customized scoring rubric or analyzing written response answers using the customized scoring rubric, an unprepared rubric customizer MLM will first analyze data from a training set to “learn” what a standard scoring rubric 104c looks like and generate a customized scoring rubric including at least customized descriptions for each grading criteria based at least in part on subject matter of each test from the course materials 104a and test materials 104b. As an example, the training dataset may include at least: (a) a plurality of standardized scoring rubrics used across different courses and tests, (b) a plurality of customized scoring rubrics comprising at least detailed criteria descriptions of each grading criteria, (c) descriptions of different proficiency levels and corresponding criteria for each level, (d) course material outlining subject matter and learning objectives of each course, and/or (e) test material comprising at least questions, answer keys, and example written responses in a variety of subjects and difficulty levels. The example written responses may include a variety of written responses each labeled with a grade, score, or feedback.

During training of the MLM from the rubric customizer MLM, the rubric training dataset (e.g., rubric training dataset 201 shown in FIG. 2) will comprise data corresponding to standardized scoring rubrics, customized scoring rubrics with detailed descriptions of each grading criteria, descriptions of proficiency levels and criteria for each proficiency level, and test materials 104b that are input through the unprepared rubric customizer MLM. The results from the unprepared rubric customizer MLM are then compared with known data set results using the corresponding labels to identify the grading criteria used for the customized scoring rubrics. It should noted that the input to the prepared MLM in the rubric customizer MLM module 110 will be data from the rubric training dataset.

For every input training sample from the rubric training dataset, the trained MLM from the rubric customizer MLM module 110 will produce a prediction consisting of values representing a probability that a grading criteria is relevant, partially relevant, or not relevant to the written response test. The output with the highest probability determines the predicted grading criteria to be used in the customized scoring rubric. A class label for each prediction may be used to compute a loss (e.g., loss function).

The trained MLM from the rubric customizer MLM module 110 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks (e.g., predicting grading criteria) or a Cross-Entropy Loss for classification tasks (e.g., detecting gradient criteria from the grading guidelines 104d).

Once the MLM is trained (e.g., inference), the trained MLM from the rubric customizer MLM module 110 may generate a customized scoring rubric for a written response test including at least customized descriptions for each grading criteria based at least on subject matter of each test and/or course and based on the standard scoring rubric 104c.

During inference, the trained MLM from the rubric customizer MLM module 110 does not re-evaluate or adjust the layers of a MLM based on the results. Instead, the inference applies knowledge from the trained neural network and uses it to infer a result (e.g., relevant, partially relevant, or not relevant). Accordingly, when a new unknown dataset (e.g., new prompt, new course material, new test materials, new grading guidelines, etc.) is input through the prepared MLM of the rubric customizer MLM module 110, the prepared MLM outputs a prediction of the gradient criteria suitable for the test materials 104b based on the predictive accuracy of the MLM.

In some aspects, each test grading MLM agent 112a, 112b, 112n is configured to evaluate the written responses independently based on a particular grading criterion (e.g., persuasion, accuracy, organization, style, voice, content, efficiency, or conventions). As an example, a first test grading MLM agent 112a may correspond to persuasion and a second test grading MLM agent 112b may correspond to accuracy. Each MLM agent applies a scoring algorithm to calculate scores for the specific grading criteria it is designed to evaluate. In some aspects, a teacher may select the test grading MLM agents based on what gradient criteria they wish to include in the customized scoring rubric for any given written response test and/or course. Selecting and having a separate test grading MLM agent for each particular grading criteria is that having different instances of MLM agents for each grading criteria allows the ML-based scoring module 102 to perform parallel processing of two or more MLM agents. The benefit of having separate MLM agents for each particular criteria is a decrease in hallucinations compared to using a general MLM agent for multiple grading criteria and an increase of speed.

During training of the MLM from the first test grading MLM agents 112, the first criteria training dataset (e.g., the first criteria training dataset 203 shown in FIG. 2) will comprise data corresponding to: (a) a plurality of customized scoring rubrics comprising at least detailed criteria descriptions of each grading criteria specific to a particular test grading MLM agent, (b) a plurality of course material and test materials, (c) a plurality of graded written responses categorized by topics and particular to a first criteria associated with the first test grading MLM agent comprising at least scores and feedback, and (d) descriptions of different proficiency levels and criteria for each level particular to the first criteria associated with the first test grading MLM agent. The results from the unprepared test grading MLM agents are then compared with known data sets results using the corresponding labels to identify the proficiency levels and criteria for each level. It should be noted that the input to the prepared test grading MLM agents will be data from the training dataset.

For every input training sample from the training dataset, the prepared first test grading MLM agent 112a will produce a prediction consisting of values representing a probability corresponding to an evaluation of the written response test in regards to the particular grading criteria. The output with the highest probability determines the proficiency level of the written response test in regards to the grading criteria. A class label for the test feedback is used to compute a loss (e.g., loss function).

Similar to the prepared rubric customizer MLM, the prepared first test grading MLM agent 112a then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the prepared first test grading MLM agent 112a is trained (e.g., inference), the prepared first test grading MLM agent 112a may analyze the written response based on an individual grading criteria from the customized scoring rubric for the written response test and/or course and to generate a criteria score for the individual grading criteria.

During inference, the prepared first test grading MLM agent 112a does not re-evaluate or adjust the layers of the MLM based on the results. Instead, the inference applies knowledge from the prepared first test grading MLM agent 112a and uses it to generate an evaluation (e.g., proficiency level for a single grading criteria). Accordingly, when a new unknown dataset (e.g., new written response test) is input through the prepared first test grading MLM agent 112a, the prepared first test grading MLM agent 112a outputs a prediction of a proficiency score of the written response test based on the single grading criteria associated with the first test grading MLM agent 112a.

It should be noted that the second testing grading MLM agent 112b and any other optional Nth test grading MLM agents 112n will be prepared and configured in the same manner and with the same type of training data as the first test grading MLM agent 112a with the exception that the second testing grading MLM agent 112b and any optional Nth test grading MLM agent 112n will each be associated with a different grading criteria than the first test grading MLM agent 112a.

In some aspects, an optimizer such as Adam or SGD may be used to train the MLMs in the rubric customizer MLM module 110, the first test grading MLM agent 112a, the second test grading MLM agent 112b, and/or the optional Nth test grading MLM agent 112n. In some aspects, the data may be split into training, validation, and test sets. In these aspects, the models from the rubric customizer MLM module 110, the first test grading MLM agent 112a, the second test grading MLM agent 112b, and/or the optional Nth test grading MLM agent 112n are trained on the training dataset and then validated by the validation sets in order to tune hyperparameters.

The computing device 101a may execute an optional criteria selection module 114 configured to obtain a selection of two or more prepared test grading MLM agents from a plurality of prepared test grading MLM agents based grading criteria from the customized scoring rubric for the written response test.

The computing device 101a may execute the scoring engine 116 configured to analyze and calculate a plurality of criteria scores from the two or more prepared test grading MLM agents according to the test scoring rules from the grading guidelines for the test and/or course to compute a test score for the written response. In some aspects, the scoring engine 116 is provided with predefined grading guidelines 104d, which detail criteria from the customized scoring rubric such as persuasion, accuracy, organization, style, voice, content, efficiency, or conventions.

The scoring engine 116 may be configured to apply test scoring rules to aggregate the intermediate scores. As a non-limiting examples, rules could include weighted average of scores or conditional rules (e.g. “if a creativity score<threshold, penalize overall score by 10%” or “ideas criteria is doubled”). In addition, if there are discrepancies, the scoring engine 116 may be configured to employ predefined resolution strategies (e.g., majority rule, tie-breaking algorithms, etc.). The scoring engine 116 may also be configured to aggregate scores across all grading criteria to compute the final test score for the written response. In some aspects, the scoring engine 116 may scale the final test score to fit the grading framework (e.g., converting raw scores to percentile rankings or grades).

In some aspects, the scoring engine 116 may also generate a grading report (e.g., the grading report 312 shown in FIG. 3) comprising at least: the test score for the written response test, the plurality of criteria scores, or descriptions for the grading criteria from the customized scoring rubric for the written response test.

In some examples, the optional second computing device 101b may execute the optional UI generation module 118 to implement a UI for display on the optional second computing device 101b that is configured to receive input from the optional second computing device 101b, analyze and score the written examination, and display grading reports for each written examination. In some aspects, the optional UI generation module 118 generates a single UI and layout and components of the UI elements (e.g., menus, buttons, forms, grids, etc.) based on predefined rules, data models, or templates. In some aspects, the optional UI generation module 118 may also be configured to automatically adjust the UI elements based on the content or data that it needs to display such as adapting a form to input fields or displaying a list of items. In some aspects, the optional UI generation module 118 may also be configured to adapt the UI to different screen sizes and resolutions by making sure that the UI works well across various devices.

It should be noted that the generation of the customized scoring rubric and analysis of the written response test using the customized scoring rubric and multiple test grading MLM agents described in the present disclosure are heavily simplified. One skilled in the art will appreciate that the MLMs utilized have significantly large datasets with highly specific details. For example, the written response test may include “open-ended” questions and there may be subtle difference between an expected answer or answer rubric and the learner's response. This type of analysis would be beyond the capabilities of the huma mind because the amount of data to be identified, considered, and processed when grading a written response test for learners is unfathomable.

It should also be noted that although the present disclosure is described in terms of evaluation examinations for illustrative purposes only, methods and systems described in the present disclosure can be applied to any type of coursework, assignment, quiz, or the like.

FIG. 2 is a block diagram illustrating a system for training MLMs to generate customized scoring rubric for written response tests and provide automated grading of the written response tests according to aspects of the present disclosure. As shown in example 200, a MLM training module 202 is configured to build and train specialized MLMs with inference to perform particular tasks. This enables the specialized MLMs to develop an ability to perform particular objectives on inputs that are not part of a training dataset (e.g., rubric training dataset 201, first criteria training dataset 203, second criteria training dataset 205, and optional nth criteria training dataset 207). By subjecting the specialized MLMs to large amounts of unlabeled and/or labeled training data sets, the specialized MLMs may perform particular tasks such as generating customized scoring rubrics and/or preparing test grading MLM to analyze and score a written response based on a single grading criteria from the customized scoring rubric.

Supervised learning is effective for tasks such as classification (assigning inputs to predefined categories) and regression (predicting continuous values) since it relies on the availability of labeled data for both training and evaluation phases. In supervised learning, the MLM training module 202 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 202 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 202 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 202 includes at least a training database 213 configured to store the raw training data 219n and corresponding labels, a MLM model database 215 to store the prepared MLM models (e.g., rubric customizer MLM model 227a, first test grading agent 227b, second test grading agent 227c, and optional Nth grading agent 227d). In some aspects, the MLM training module 202 may include an optional filtering MLM module 229 and an optional filter module 217 configured to filter data from the training database 213 for training by removing poorly generated training data.

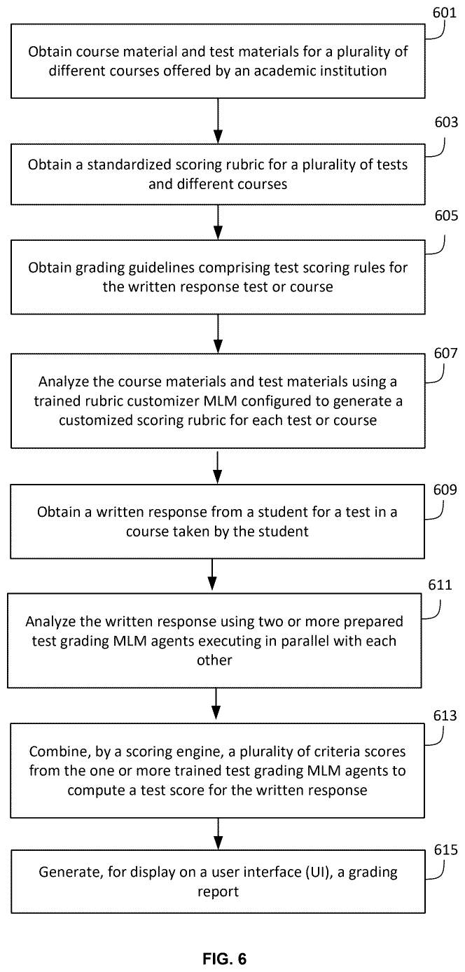

Training data from the rubric training dataset 201, first criteria training database 203, second criteria training dataset 205, and optional nth criteria training dataset 207 is received into the MLM training module 202 via the training set generator 211. Details about the data included in each training dataset is described in more detail above with FIG. 1 and below in FIG. 6.

The optional filtering MLM module 229 is configured to filter out bad training images and/or data in order to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a, preprocess 2 223b, preprocess 3 223c, and preprocess N 223d are automated processes that modify the raw data received from 219n (or cleaned training dataset 221n) and prepare the raw data as input to the respective model trainers (e.g., rubric customizer MLM model trainer 225a, 1^{st} test grading agent trainer 225b, 2^{nd} test grading agent trainer 225c, and Nth test grading agent trainer 225n). These may be described in the MLM training module 202 as snippets of code that prepares the datasets. In some examples, the preprocessing module (e.g., preprocess 1 223a, preprocess 2 223b, preprocess 3 223c, and preprocess N 223n) for a particular trainer may be an automated script or code that will be setup the first time any model is trained.

The rubric customizer MLM model trainer 225a, 1^{st} test grading agent trainer 225b, 2^{nd} test grading agent trainer 225c, and Nth test grading agent trainer 225n are the scripts or code that train the respective models. The rubric customizer MLM model trainer 225a, first test grading agent trainer 225b, second test grading agent trainer 225c, and Nth test grading agent trainer 225n may be a script or code that holds the instructions on how a model should be trained (e.g., optimization method, model architecture, dataset division, etc.) and also runs the training. The-rubric customizer MLM model trainer 225a, first test grading agent trainer 225b, second test grading agent trainer 225c, and Nth test grading agent trainer 225n each take as input the raw or filtered processed training data and train the rubric customizer MLM model 227a, the first test grading agent 227b, the second test grading agent 227c, and the optional Nth test grading agent 227n to achieve their specific objectives, respectively.

In summary, the raw dataset 219 or cleaned dataset 221n may optionally go through different preprocessing steps 223a, 223b, 223c, 223n and then a corresponding rubric customizer MLM model trainer 225a, 1^{st} test grading agent trainer 225b, 2^{nd} test grading agent trainer 225c, and Nth test grading agent trainer 225n to generate a prepared rubric customizer MLM model 227a, first test grading agent 227b, second test grading agent 227c, and optional Nth test grading agent 227n. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training images from the training database 213. Accordingly, to create a clean and filtered training dataset, the optional filter module 217 is configured to filter out unwanted data points from the raw training dataset 219n by developing smaller, less accurate systems based on patterns and metadata information.

During the training process, the rubric customizer MLM model trainer 225a, the 1st test grading agent trainer 225b, the 2^{nd} test grading agent trainer 225c, and the optional Nth test grading agent trainer 225n are presented with input data and labels of actual values, and the optimization objective, which aims to minimize the difference between the actual value and the predicted value, is calculated. The optimization algorithm updates the parameters of the rubric customizer MLM model trainer 225a, the 1^{st} test grading agent trainer 225b, the 2^{nd} test grading agent trainer 225c, and the optional Nth test grading agent trainer 225n to reduce the value of the objective. This process is repeated for several iterations until the parameters do not change anymore. This process is repeated for various combinations of hyperparameters, and the model with the smallest label prediction error is selected as the final model.

When a new model (e.g., prepared rubric customizer MLM model 227a, first test grading agent 227b, second test grading agent 227c, and optional Nth test grading agent 227n) is created, and a new process for filtering and automated labeling is established, it is added to the MLM model database 215 in the MLM training module 202. This enables the new model to be part of the closed-loop model update process. Optionally, at regular intervals, data which is continuously collected can be filtered, labeled, and used to update old models by the optional filtering MLM module 229. In some examples, the optional filtering MLM module 229 is a neural network. In some examples, the optional filtering MLM module 229 is a mathematical model. This approach may capture changes in the data over time.

FIG. 3 is an example method for generating a customized scoring rubric and performing automated grading of a written test using the customized scoring rubric according to an aspect of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes a method for generating a customized scoring rubric and performing automated grading of a written test using the customized scoring rubric.

The method 300 beings by inputting course material 104a, test materials 104b, and standard scoring rubric 104c, and grading guidelines 104d into a rubric customizer MLM model 227a to generate a customized scoring rubric 302.

In some aspects, course materials 104a provides the foundational knowledge and concepts that the customized scoring rubric 302 should assess. As a non-limiting example, the rubric customizer MLM model 227a may utilize the course materials 104a to extract key topics, concepts, and learning objects using natural language processing (NLP). As another example, the rubric customizer MLM model 227a may use embeddings (e.g., BERT, GPT-derived models) to map content from the course materials 104a to standardized knowledge domains. In this way, content from the course materials 104a may be aligned to rubric categories from the customized scoring rubric 302 such as compression, application, analysis or the like. In addition, contextual data from the course materials 104a may also guide sections of the customized scoring rubric 302 such as weighting criteria or specific focus areas.

In some aspects, test materials 104b may include the actual prompt, directions, and materials that highlight specific questions or tasks that learners are expected to answer and/or perform on the written response test. As a non-limiting example, the rubric customizer MLM model 227a may utilize the test materials 104b to identify the type of questions (e.g., essay, problem-solving) using NLP, match test items to course objectives to ensure that the customized scoring rubric 302 evaluates all required competencies, and identify keywords or patterns that suggest scoring elements (e.g., partial credit, key steps, etc.).

In some aspects, the standard scoring rubric 104c provides a reference framework of best practices for generating the customized scoring rubric 302. As a non-limiting example, the rubric customizer MLM model 227a may utilize the standard scoring rubric 104c as input as pre-labeled data for supervised learning models, extract common rubric dimensions (e.g., clarity, structure, content accuracy, etc.) and map them to the course-specific goals, and identify consistent patterns across rubrics and use them to generate rubric templates for the customized scoring rubric 302.

In some aspects, the grading guidelines 104d defines policies and criteria for fair and consistent grading of the written response. As a non-limiting example, the rubric customizer MLM model 227a may utilize the grading guidelines 104d to encode rules (e.g., weight distribution, penalties, late submission policies) as features in the rubric customizer MLM model 227a, integrate grading scales (e.g., A-F, 1-5, percentage, pass/fail) and ensure alignment in rubric output, and calibrate model outputs for edge cases such as borderline grades.

At a high level, the rubric customizer MLM model 227a's model workflow includes preprocessing, feature engineering, model training, customization, and evaluation/feedback. The preprocessing step includes at least tokenizing and encoding all textual inputs using NLP techniques and parsing numerical or categorical data from the grading guidelines 104d and standard scoring rubrics 104c. The feature engineering step includes at least combining text embeddings with structured features (e.g., weight distributions, grading criteria) and developing a hierarchy of concepts from course materials 104a and test materials 104b. The model training step includes using supervised learning with historical rubrics as labeled data and incorporating unsupervised learning to identify patterns or clusters in scoring rubrics. The customization step includes at least adding user input as an optional feature (e.g., a teacher's specific preferences) and generating an initial draft of the customized scoring rubric 302 to allow for iterative refinement. The evaluation/feedback step includes at least testing the rubric customizer MLM model 227a on historical test materials and comparing its output to actual scoring rubrics and refining the rubric customizer MLM model 227a based on discrepancies. In some examples, the refinement may focus on teacher feedback and rubric usability.

Finally, the rubric customizer MLM model 227a will generate a customized scoring rubric 302 that includes at least clearly defined criteria (e.g., content, originality, grammar), scoring wrights tailored to course goals and test difficulty, and/or grading guidelines 104d integrated into the structure of the customized scoring rubric 302. As an example, the customized scoring rubric comprises at least customized descriptions for each grading criteria based at least on subject matter of each test and/or course. In this way, the customized scoring rubric 302 is aligned with educational objectives, consistent with institutional policies, and adaptable to specific assessments. In some aspects, the grading criteria from the customized scoring rubric 302 may include at least persuasion, accuracy, organization, style, voice, content, efficiency, or conventions.

The first test grading agent 227b, the second test grading agent 227c, and optional Nth test grading agent 227d obtains the customized scoring rubric 302, the written response 306, and the written response 306 in order to generate an individual criteria score 308 for each test grading agent. Each test grading agent is associated with a particular grading criteria and is prepared to analyze the written response 306 based on a single grading criteria from the customized scoring rubric 302 for the test 304.

The scoring engine 116 obtains the individual criteria scores 308 and is configured to combine the plurality of individual criteria scores 308 from at least the first test grading agent 227b and the second test grading agent 227c according to the test scoring rules from the grading guidelines 104d to compute an overall test score 310 for the written responses 306.

In some aspects, the method 300 also generates a grading report 312 including at least: the overall test score 310 for the written response, the plurality of individual criteria scores 308, and/or descriptions for the grading criteria from the customized scoring rubric 302 for the test 304.

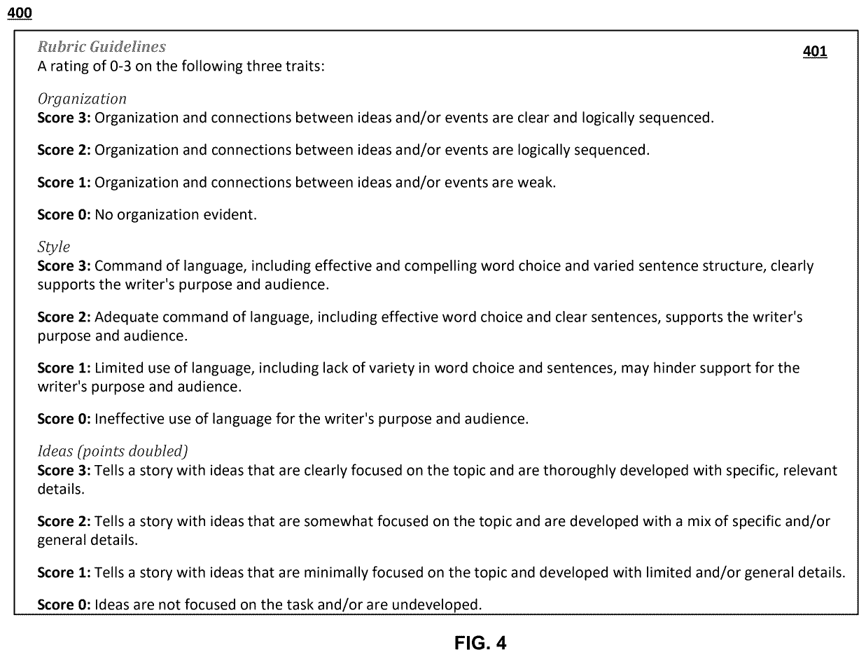

FIG. 4 is an example of a customized scoring rubric according to aspects of the present disclosure. FIG. 4 shows an example 400 of a customized scoring rubric 401 that includes the grading criteria of organization, style, and ideas. In addition, the example 400 also includes customized descriptions of the different criteria scores (e.g., 0, 1, 2, 3) for each level of grading criteria (e.g., organization, style, and ideas). In addition, the customized scoring rubric 401 also includes a rule of the Ideas grading criteria having twice as much weight as the organization and style grading criteria.

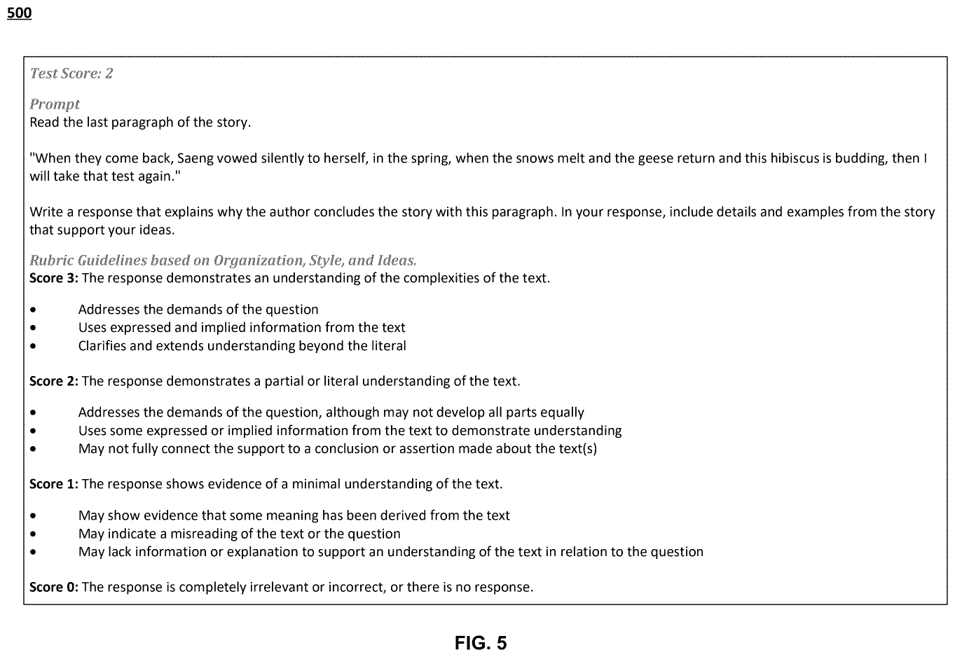

FIG. 5 is an example of a graded written response and a customized scoring rubrics according to aspects of the present disclosure. FIG. 5 shows an example 500 of a grading report containing at least an overall test score (e.g., 2), a prompt of the written response test, instructions for the written response, and a plurality of criteria scores along with descriptions for the grading criteria from the customized scoring rubric for the test.

FIG. 6 is an example method for automated grading of written response tests according to aspects of the present disclosure. In various implementations, the method 600 is performed by a device with one or more processors and non-transitory memory that performs intent prediction. In some implementations, the method 300 is performed by processing logic, including hardware, firmware, software, or a combination thereof. In some implementations, the method 600 is performed by a processor executing code stored in a non-transitory computer-readable medium (e.g., a memory). The method 600 describes a method for generating a customized scoring rubric and performing automated grading of a written test using the customized scoring rubric.

At 601, the method 600 may include obtaining course material and test materials for a plurality of different courses offered by an academic institution. The test materials may include a written response test.

At 603, the method 600 may include obtaining a standardized scoring rubric for a plurality of tests and different courses. The standardized scoring rubric may be the same for the plurality of courses. A standardized scoring rubric ensures that all tests, regardless of subject or course, are evaluated based on a common framework. This consistency makes it easier to compare results across different tests and courses, ensuring fairness and transparency. If a customized rubric is based on a standardized one, it helps maintain the same evaluation principles even when the specifics of the rubric change to fit different types of assessments. In addition, the standardized rubric can serve as a baseline, which can then be modified to account for the unique aspects of each test or course. This reduces the need to reinvent the wheel for each new assessment and minimizes the risk of overlooking important evaluation criteria.

At 605, the method 600 may include obtaining grading guidelines comprising test scoring rules for the written response test or course. The grading guidelines help ensure that the test scoring aligns with the learning objectives or outcomes of the course. For instance, if the course focuses on critical thinking, the scoring rules may prioritize how well a learner supports their arguments with evidence. When generating a customized rubric, these guidelines ensure that the rubric accurately reflects the key learning goals of the course, leading to more targeted and relevant assessments. In addition, grading guidelines may also be designed to provide specific feedback on each aspect of a learner's performance. For example, if one of the scoring rules focuses on the clarity of writing, the rubric can include a section that specifically addresses this criterion. This helps learners understand not only their overall grade but also the specific areas where they excelled or need improvement, providing more meaningful feedback. When grading is automated or assisted by machine learning (e.g., using LLMs), having clear test scoring rules helps train algorithms to assess responses correctly. These rules provide the necessary parameters that guide the automated system to evaluate responses accurately and consistently, even when handling complex, open-ended written responses.

At 607, the method 600 may include analyzing the course materials and test materials using a prepared rubric customizer machine learning model (MLM) configured to generate a customized scoring rubric for the written response test or course based on the standardized scoring rubric. The customized scoring rubric may include at least a list of different grading criteria, customized descriptions for each grading criteria based at least on subject matter of the written response test and/or course, and criteria score levels for each grading criteria.

Having different grading criteria, customized descriptions for each grading criterion based on the subject matter of the written response test and/or course, and criteria score levels for each grading criterion is essential when generating a customized scoring rubric for several important reasons.

First, each subject or course has its own set of learning objectives and key skills that learners are expected to demonstrate. By customizing the grading criteria to match the subject matter, the rubric ensures that the assessment directly evaluates the most important competencies. For example, a history essay might be graded on the accuracy of historical facts and depth of analysis, while a literature response could focus more on interpretation, creativity, and argumentation. Customizing the grading criteria based on subject matter ensures that the rubric aligns with the intended learning outcomes of the course or test.

Second, customized descriptions for each grading criterion help clarify what learners need to focus on in their written responses. By tailoring the descriptions to reflect the specific aspects of the subject matter, learners gain a better understanding of what is expected in their answers. For example, a writing test might include criteria for “grammar and syntax” or “logical flow” for an English class, whereas in a science class, criteria might focus on “accuracy of data” and “clarity of hypothesis.” Customized descriptions prevent confusion and guide learners to provide responses that are aligned with the grading expectations.

Third, different grading criteria tailored to the subject matter allow for a more precise and nuanced assessment of learner performance. When grading a history essay, for example, a criterion for “historical analysis” can help focus on how well learners contextualize events and draw conclusions based on evidence. In contrast, in a mathematics test, a criterion for “problem-solving process” might be more appropriate. By including specific criteria for each subject, the present disclosure avoids the pitfalls of one-size-fits-all rubrics, which may overlook subject-specific requirements and lead to imprecise evaluations.

In some aspects, the method 600 may include preparing the rubric customizer MLM by: (i) providing, to the rubric customizer MLM, a training dataset comprising: (a) a plurality of standardized scoring rubrics used across different courses and tests, (b) a plurality of customized scoring rubrics comprising at least detailed criteria descriptions of each grading criteria, (c) descriptions of different proficiency levels and corresponding criteria for each level, (d) course material outlining subject matter and learning objectives of each course, and (e) test material comprising at least questions, answer keys, and example written responses in a variety of subjects and difficulty levels, wherein the example written responses comprises a variety of written responses each labeled with a grade, score, or feedback, and (ii) training the rubric customizer MLM using the provided training dataset.

In some aspects, the different grading criteria from the customed scoring rubric comprises at least two of: persuasion, accuracy, organization, style, voice, content, efficiency, or conventions.

At 609, the method 600 may include obtaining a written response from a learner for a test in a course taken by the learner. In some aspects, the method 600 may include a large amounts of written responses from each learner in a class.

At 611, the method 600 may include analyzing the written response using two or more prepared test grading MLM agents executing in parallel with each other. Each test grading MLM agent may be associated with a single grading criteria from the customized scoring rubric and configured to analyze the written response based on the single grading criteria from the customized scoring rubric for the written response test and/or course and to generate a criteria score for the single grading criteria.

Using two or more prepared test grading MLM (Machine Learning Model) agents executing in parallel, each associated with a single grading criterion from the customized scoring rubric, offers several distinct advantages in the context of grading written response tests or courses. Each MLM agent is assigned to a single grading criterion from the customized rubric, enabling the model to specialize in evaluating a particular aspect of the response (e.g., grammar, content accuracy, argument strength, coherence, etc.). This specialization leads to a more precise and detailed assessment of each individual aspect of the learner's work. Since each agent focuses on one criterion, it can evaluate that criterion more thoroughly, ensuring a higher degree of accuracy.

Running multiple test grading MLM agents in parallel enables the system to process responses more efficiently. Each agent works independently, evaluating different grading criteria simultaneously, which significantly reduces the overall time required to grade a response. This is especially valuable in situations with large volumes of assessments or when quick feedback is needed for learners. The parallel processing speeds up grading without sacrificing quality.

When multiple test grading MLM agents independently analyze different grading criteria, it helps minimize bias and ensures that the grading remains consistent. Since each agent evaluates a specific aspect of the response, there is less room for subjectivity, and each criterion is evaluated independently from others. This can result in a more uniform application of grading standards across all written responses, especially when dealing with a variety of graders.

Grading written responses often requires evaluating multiple dimensions of a learner's work (e.g., writing quality, argumentation, creativity, accuracy, structure, etc.). By using multiple agents, each focused on a different criterion, the system can simultaneously evaluate all relevant aspects of the response in a way that a single agent might struggle with. This allows for a more comprehensive evaluation of the learner's work, accounting for the complexity of human expression and thought.

By dividing the task of grading into multiple, focused agents, the system reduces the likelihood of errors that may arise from a single model trying to handle too many diverse aspects of grading at once. Each agent is tasked with a smaller, more manageable subset of the grading problem, lowering the chance for mistakes due to overfitting, underfitting, or model limitations. Multiple independent agents can also act as a form of redundancy, catching potential misjudgments or inconsistencies made by individual agents.

In some aspects, the method 600 may include preparing a first test grading MLM agent among the two or more prepared test grading MLM agents executing in parallel with each other by: (i) providing, to the first test grading MLM agent, a first criteria training dataset comprising: (a) a plurality of customized scoring rubrics comprising at least detailed criteria descriptions of each grading criteria, (b) a plurality of course material and test materials, (c) a plurality of graded written responses categorized by topics and particular to a first criteria associated with the first test grading MLM agent comprising at least scores and feedback, and (d) descriptions of different proficiency levels and criteria for each level particular to the first criteria associated with the first test grading MLM agent, and (ii) training the first test grading MLM agent using the provided first criteria training dataset.

In some aspects, the method 600 may include: preparing a second test grading MLM agent among the two or more trained test grading MLM agents executing in parallel with each other by: (i) providing, to the second test grading MLM agent, a second criteria training dataset comprising: (a) a plurality of customized scoring rubrics comprising at least detailed criteria descriptions of each grading criteria, (b) a plurality of course material and test materials, (c) a plurality of graded written responses categorized by topics and particular to a second criteria associated with the first test grading MLM agent comprising at least scores and feedback, wherein the second criteria is different from the first criteria, and (d) descriptions of different proficiency levels and criteria for each level particular to the criteria associated with the first test grading MLM agent, and (ii) training the second test grading MLM agent using the provided second criteria training dataset, wherein the second test grading MLM agent is different from the first test grading MLM agent.

In some aspects, the prepared rubric customizer machine learning model (MLM) and the two or more prepared test grading MLM agents executing in parallel with each other correspond to LLMs. LLMs like GPT are well-suited for preparing and customizing scoring rubrics for written response tests and courses for several reasons.

First, LLMs excel at understanding and generating human language. Accordingly, LLMs can be trained to recognize patterns and meaning in written responses, which makes them highly effective at analyzing answers against a customized rubric. When configured for specific grading criteria, the model can evaluate written responses based on how well they meet those criteria, whether it's grammar, argument quality, clarity, or relevance.

Second, LLMS can be easily fine-tuned to understand and apply different types of grading criteria. For example, a standardized scoring rubric might be used as a base, and then the model can be customized to interpret variations in how different instructors or institutions define the quality of answers. This allows the machine learning model to adapt and generate a scoring rubric specific to the requirements of each test or course.

Third, LLMs can be configured to analyze a written response according to a single grading criterion. LLMs can evaluate the response based on specific traits, such as clarity, organization, relevance, or even creativity, and assign a score based on the rubric. This flexibility enables efficient grading, particularly when dealing with large volumes of written responses.

Fourth, LLMs can be trained to recognize the context of the prompt and the appropriate response. This allows them to score responses based on how well they adhere to the specific context or the requirements outlined in the rubric. For instance, an essay written for a history course will be evaluated differently than one written for a literature course, even though both might use a similar rubric structure.

Fifth, written responses can vary widely in structure and content. LLMs are capable of evaluating these varied responses without being biased by non-essential aspects (such as formatting). They focus on the quality of the content in relation to the rubric, even if the response is unconventional or unique in its approach.

Finally, LLMs can process and evaluate many written responses at once, making them scalable for large assessments or courses. Traditional grading methods often struggle with scaling due to time and resource constraints, but an LLM can analyze thousands of responses quickly and efficiently, allowing for mass deployment in educational settings.

In some aspects, the method 600 may include selecting the two or more prepared test grading MLM agents from a plurality of prepared test grading MLM agents based on the different grading criteria from the customized scoring rubric for each written response test and/or course.

A teacher would want to select different prepared test grading MLM agents from a plurality of available agents, each responsible for evaluating a different grading criterion from the customized scoring rubric for several important reasons.

First, different grading criteria require distinct evaluation skills and domain knowledge. For example, grammar and writing quality might require a different focus compared to argument structure or content accuracy. By selecting an MLM agent specialized for each grading criterion, the teacher ensures that each aspect of the learner's response is assessed by an agent trained to recognize and evaluate that specific feature at a high level of precision. This specialization results in more accurate and reliable grading for each aspect of the written response.

Second, different courses and tests prioritize different aspects of learner responses. In a history test, the teacher might prioritize the accuracy of historical facts and the depth of analysis, while in a literature test, the focus might be on the clarity of the argument and interpretation of themes. By selecting different prepared MLM agents for each specific criterion, the teacher can tailor the grading process to the unique needs of the course or assessment. This ensures that the rubric reflects the important aspects of each subject and provides a meaningful evaluation aligned with course objectives.

Third, some grading criteria, like logical coherence or persuasiveness, require a nuanced understanding of the response. Selecting a dedicated MLM agent that is specifically trained to evaluate that criterion helps avoid inaccuracies or inconsistencies in the grading process. For example, an agent focused on content accuracy can ensure that the response is factually correct, while another agent specialized in writing style ensures the clarity and fluency of the language used. This division of labor between different agents reduces the chances of misjudgment that might occur if a single agent tries to assess multiple unrelated criteria.

Fourth, some rubrics may require more complex or diverse grading criteria, particularly in courses with interdisciplinary content or multifaceted assignments. For example, an essay might need to be evaluated for writing mechanics, argumentation quality, factual accuracy, and creativity. By selecting different MLM agents for each of these areas, the teacher can effectively handle such complex rubrics without forcing a single agent to manage all of these diverse factors at once. This flexibility allows for more granular and accurate assessment based on the specific areas that are prioritized in the rubric.

At 613, the method 600 may include combining, by a scoring engine, a plurality of criteria scores from the two or more prepared test grading MLM agents according to the test scoring rules from the grading guidelines for the written response test and/or course to compute a test score for the written response test.

At 615, the method 600 may include generating, for display on a user interface (UI), a grading report comprising at least: the test score for the written response test, the plurality of criteria scores, or descriptions for the grading criteria from the customized scoring rubric for the written response test. A grading report that includes test scores, criteria scores, and descriptions for the grading criteria from the customized rubric is invaluable in enhancing transparency, communication, and learning outcomes. It offers clear, actionable feedback, promotes fairness in grading, and provides learners with the information they need to improve in specific areas. Such detailed reporting helps learners track their progress, fosters self-reflection, and improves the overall learning experience. It also ensures that grading is transparent, consistent, and based on clear, well-defined criteria, making it an essential tool for both teachers and learners.

In addition, including specific criteria scores and descriptions of each grading criterion in the report provides learners with actionable feedback. Instead of just receiving a vague score (e.g., “3/5”, “C”, or “75%”), learners can see detailed insights on what areas need improvement, whether it's argument strength, content accuracy, or organization. This allows learners to focus on specific areas for improvement in future assignments or exams, making the feedback far more useful for learning and growth.

Finally, with a grading report that lists individual criteria scores along with descriptions, the grading process becomes more structured and clearer. Learners can differentiate between their strengths and weaknesses in various aspects of their responses. For instance, a learner might excel in writing quality but need improvement in critical thinking. This clarity allows both the teacher and the learner to have a more meaningful discussion about the grade and the areas that can be improved.

FIG. 7 is a block diagram illustrating a computer system 20 on which aspects of systems and methods for an online examination proctoring system may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for automated grading of written response tests, the method comprising:
obtaining course material and test materials for a plurality of different courses offered by an academic institution, wherein the test materials comprises a written response test;
obtaining a standardized scoring rubric for a plurality of tests and different courses, wherein the standardized scoring rubric is the same for the plurality of courses;
obtaining grading guidelines comprising test scoring rules for the written response test or course;
analyzing the course materials and test materials using a prepared rubric customizer machine learning model (MLM) configured to generate a customized scoring rubric for the written response test or course based on the standardized scoring rubric, wherein the customized scoring rubric comprises at least a list of different grading criteria, customized descriptions for each grading criteria based at least on subject matter of the written response test and/or course, and criteria score levels for each grading criteria;
obtaining a written response from a learner for a test in a course taken by the learner;
analyzing the written response using two or more prepared test grading MLM agents executing in parallel with each other, wherein each test grading MLM agent is associated with a single grading criteria from the customized scoring rubric and configured to analyze the written response based on the single grading criteria from the customized scoring rubric for the written response test and/or course and to generate a criteria score for the single grading criteria;
combining, by a scoring engine, a plurality of criteria scores from the two or more prepared test grading MLM agents according to the test scoring rules from the grading guidelines for the written response test and/or course to compute a test score for the written response test; and
generating, for display on a user interface (UI), a grading report comprising at least: the test score for the written response test, the plurality of criteria scores, or descriptions for the grading criteria from the customized scoring rubric for the written response test.

2. The method of claim 1, wherein analyzing the written response using the two or more prepared test grading MLM agents further comprises:
selecting the two or more prepared test grading MLM agents from a plurality of prepared test grading MLM agents based on the different grading criteria from the customized scoring rubric for each written response test and/or course.

3. The method of claim 1, wherein the different grading criteria from the customed scoring rubric comprises at least two of: persuasion, accuracy, organization, style, voice, content, efficiency, or conventions.

4. The method of claim 1, further comprising:
preparing the rubric customizer MLM by:
(i) providing, to the rubric customizer MLM, a training dataset comprising:
(a) a plurality of standardized scoring rubrics used across different courses and tests,
(b) a plurality of customized scoring rubrics comprising at least detailed criteria descriptions of each grading criteria,
(c) descriptions of different proficiency levels and corresponding criteria for each level,
(d) course material outlining subject matter and learning objectives of each course, and
(e) test material comprising at least questions, answer keys, and example written responses in a variety of subjects and difficulty levels, wherein the example written responses comprises a variety of written responses each labeled with a grade, score, or feedback, and
(ii) training the rubric customizer MLM using the provided training dataset.

5. The method of claim 1, further comprising:
preparing a first test grading MLM agent among the two or more prepared test grading MLM agents executing in parallel with each other by:
(i) providing, to the first test grading MLM agent, a first criteria training dataset comprising:
(a) a plurality of customized scoring rubrics comprising at least detailed criteria descriptions of each grading criteria,
(b) a plurality of course material and test materials,
(c) a plurality of graded written responses categorized by topics and particular to a first criteria associated with the first test grading MLM agent comprising at least scores and feedback, and
(d) descriptions of different proficiency levels and criteria for each level particular to the first criteria associated with the first test grading MLM agent, and
(ii) training the first test grading MLM agent using the provided first criteria training dataset.

6. The method of claim 5, further comprising:
preparing a second test grading MLM agent among the two or more trained test grading MLM agents executing in parallel with each other by:
(i) providing, to the second test grading MLM agent, a second criteria training dataset comprising:
(a) a plurality of customized scoring rubrics comprising at least detailed criteria descriptions of each grading criteria,
(b) a plurality of course material and test materials,
(c) a plurality of graded written responses categorized by topics and particular to a second criteria associated with the first test grading MLM agent comprising at least scores and feedback, wherein the second criteria is different from the first criteria, and
(d) descriptions of different proficiency levels and criteria for each level particular to the criteria associated with the first test grading MLM agent, and
(ii) training the second test grading MLM agent using the provided second criteria training dataset, wherein the second test grading MLM agent is different from the first test grading MLM agent.

7. The method of claim 1, wherein the prepared rubric customizer machine learning model (MLM) and the two or more prepared test grading MLM agents executing in parallel with each other correspond to large language models (LLMs).

8. A system for automated grading of written response tests, comprising:
at least one memory;
at least one hardware processor coupled with the at least one memory and configured, individually or in combination, to:
obtain course material and test materials for a plurality of different courses offered by an academic institution, wherein the test materials comprises a written response test;
obtain a standardized scoring rubric for a plurality of tests and different courses, wherein the standardized scoring rubric is the same for the plurality of courses;
obtain grading guidelines comprising test scoring rules for the written response test or course;
analyze the course materials and test materials using a prepared rubric customizer machine learning model (MLM) configured to generate a customized scoring rubric for each written response test or course based on the standardized scoring rubric, wherein the customized scoring rubric comprises at least a list of different grading criteria, customized descriptions for each grading criteria based at least on subject matter of each written response test and/or course, and criteria score levels for the grading criteria;
obtain a written response from a learner for a test in a course taken by the learner;
analyze the written response using two or more prepared test grading MLM agents executing in parallel with each other, wherein each test grading MLM agent is associated with a single grading criteria from the customized scoring rubric and configured to analyze the written response based on the single grading criteria from the customized scoring rubric for the written response test and/or course and to generate a criteria score for the single grading criteria;
combine, by a scoring engine, a plurality of criteria scores from the two or more prepared test grading MLM agents according to the test scoring rules from the grading guidelines for the written response test and/or course to compute a test score for the written response test; and
generate, for display on a user interface (UI), a grading report comprising at least: the test score for the written response test, the plurality of criteria scores, or descriptions for the grading criteria from the customized scoring rubric for the written response test.

9. The system of claim 8, wherein analyzing the written response using the two or more prepared test grading MLM agents further comprises:
selecting the two or more prepared test grading MLM agents from a plurality of prepared test grading MLM agents based on the different grading criteria from the customized scoring rubric for each written response test and/or course.

10. The system of claim 8, wherein the different grading criteria from the customed scoring rubric comprises at least two of: persuasion, accuracy, organization, style, voice, content, efficiency, or conventions.

11. The system of claim 8, wherein the least one hardware processor coupled with the at least one memory and is further configured, individually or in combination, to:
prepare the rubric customizer MLM by:
(i) providing, to the rubric customizer MLM, a training dataset comprising:
(a) a plurality of standardized scoring rubrics used across different courses and tests,
(b) a plurality of customized scoring rubrics comprising at least detailed criteria descriptions of each grading criteria,
(c) descriptions of different proficiency levels and corresponding criteria for each level,
(d) course material outlining subject matter and learning objectives of each course, and
(e) test material comprising at least questions, answer keys, and example written responses in a variety of subjects and difficulty levels, wherein the example written responses comprises a variety of written responses each labeled with a grade, score, or feedback, and
(ii) training the rubric customizer MLM using the provided training dataset.

12. The system of claim 8, wherein the least one hardware processor coupled with the at least one memory and is further configured, individually or in combination, to:
prepare a first test grading MLM agent among the two or more prepared test grading MLM agents executing in parallel with each other by:
(i) providing, to the first test grading MLM agent, a first criteria training dataset comprising:
(a) a plurality of customized scoring rubrics comprising at least detailed criteria descriptions of each grading criteria,
(b) a plurality of course material and test materials,
(c) a plurality of graded written responses categorized by topics and particular to a first criteria associated with the first test grading MLM agent comprising at least scores and feedback, and
(d) descriptions of different proficiency levels and criteria for each level particular to the first criteria associated with the first test grading MLM agent, and
(ii) training the first test grading MLM agent using the provided first criteria training dataset.

13. The system of claim 12, wherein the least one hardware processor coupled with the at least one memory and is further configured, individually or in combination, to:
prepare a second test grading MLM agent among the two or more trained test grading MLM agents executing in parallel with each other by:
(i) providing, to the second test grading MLM agent, a second criteria training dataset comprising:
(a) a plurality of customized scoring rubrics comprising at least detailed criteria descriptions of each grading criteria,
(b) a plurality of course material and test materials,
(c) a plurality of graded written responses categorized by topics and particular to a second criteria associated with the first test grading MLM agent comprising at least scores and feedback, wherein the second criteria is different from the first criteria, and
(d) descriptions of different proficiency levels and criteria for each level particular to the criteria associated with the first test grading MLM agent, and
(ii) training the second test grading MLM agent using the provided second criteria training dataset, wherein the second test grading MLM agent is different from the first test grading MLM agent.

14. The system of claim 8, wherein the prepared rubric customizer machine learning model (MLM) and the two or more prepared test grading MLM agents executing in parallel with each other correspond to large language models (LLMs).

15. A non-transitory computer readable medium storing thereon computer executable instructions for automated grading of written response tests, including instructions for:
obtaining course material and test materials for a plurality of different courses offered by an academic institution, wherein the test materials comprises a written response test;
obtaining a standardized scoring rubric for a plurality of tests and different courses, wherein the standardized scoring rubric is the same for the plurality of courses;
obtaining grading guidelines comprising test scoring rules for the written response test or course;
analyzing the course materials and test materials using a prepared rubric customizer machine learning model (MLM) configured to generate a customized scoring rubric for each written response test or course based on the standardized scoring rubric, wherein the customized scoring rubric comprises at least a list of different grading criteria, customized descriptions for each grading criteria based at least on subject matter of each written response test and/or course, and criteria score levels for the grading criteria,
obtaining a written response from a learner for a test in a course taken by the learner;
analyzing the written response using two or more prepared test grading MLM agents executing in parallel with each other, wherein each test grading MLM agent is associated with a single grading criteria from the customized scoring rubric and configured to analyze the written response based on the single grading criteria from the customized scoring rubric for the written response test and/or course and to generate a criteria score for the single grading criteria;
combining, by a scoring engine, a plurality of criteria scores from the two or more prepared test grading MLM agents according to the test scoring rules from the grading guidelines for the written response test and/or course to compute a test score for the written response test; and
generating, for display on a user interface (UI), a grading report comprising at least: the test score for the written response test, the plurality of criteria scores, or descriptions for the grading criteria from the customized scoring rubric for the written response test.

16. The non-transitory computer readable medium of claim 15, analyzing the written response using the two or more prepared test grading MLM agents further comprises:
selecting the two or more prepared test grading MLM agents from a plurality of prepared test grading MLM agents based on the different grading criteria from the customized scoring rubric for each written response test and/or course.

17. The non-transitory computer readable medium of claim 15, wherein the different grading criteria from the customed scoring rubric comprises at least two of: persuasion, accuracy, organization, style, voice, content, efficiency, or conventions.

18. The non-transitory computer readable medium of claim 15, further including instructions for:
preparing the rubric customizer MLM by:
(i) providing, to the rubric customizer MLM, a training dataset comprising:
(a) a plurality of standardized scoring rubrics used across different courses and tests,
(b) a plurality of customized scoring rubrics comprising at least detailed criteria descriptions of each grading criteria,
(c) descriptions of different proficiency levels and corresponding criteria for each level,
(d) course material outlining subject matter and learning objectives of each course, and
(e) test material comprising at least questions, answer keys, and example written responses in a variety of subjects and difficulty levels, wherein the example written responses comprises a variety of written responses each labeled with a grade, score, or feedback, and
(ii) training the rubric customizer MLM using the provided training dataset.

19. The non-transitory computer readable medium of claim 15, further including instructions for:
preparing a first test grading MLM agent among the two or more prepared test grading MLM agents executing in parallel with each other by:
(i) providing, to the first test grading MLM agent, a first criteria training dataset comprising:
(a) a plurality of customized scoring rubrics comprising at least detailed criteria descriptions of each grading criteria,
(b) a plurality of course material and test materials,
(c) a plurality of graded written responses categorized by topics and particular to a first criteria associated with the first test grading MLM agent comprising at least scores and feedback, and
(d) descriptions of different proficiency levels and criteria for each level particular to the first criteria associated with the first test grading MLM agent, and
(ii) training the first test grading MLM agent using the provided first criteria training dataset.

20. The non-transitory computer readable medium of claim 19, further including instructions for:
preparing a second test grading MLM agent among the two or more trained test grading MLM agents executing in parallel with each other by:
(i) providing, to the second test grading MLM agent, a second criteria training dataset comprising:
(a) a plurality of customized scoring rubrics comprising at least detailed criteria descriptions of each grading criteria,
(b) a plurality of course material and test materials,
(c) a plurality of graded written responses categorized by topics and particular to a second criteria associated with the first test grading MLM agent comprising at least scores and feedback, wherein the second criteria is different from the first criteria, and
(d) descriptions of different proficiency levels and criteria for each level particular to the criteria associated with the first test grading MLM agent, and
(ii) training the second test grading MLM agent using the provided second criteria training dataset, wherein the second test grading MLM agent is different from the first test grading MLM agent.
